(19) United States
(12) Patent Application Publication
(10) Pub. No.: US 2026/0300503 A1
(43) Pub. Date: Oct. 1, 2026

(54) VULNERABILITY ANALYSIS SYSTEM AND VULNERABILITY ANALYSIS METHOD

(71) Applicant: Panasonic Automotive Systems Co., Ltd., Kanagawa (JP)

(72) Inventors: Yuishi TORISAKI, Osaka (JP); Shoichiro SEKIYA, Osaka (JP)

(73) Assignee: Panasonic Automotive Systems Co., Ltd., Kanagawa (JP)

(21) Appl. No.: 19/430,689

(22) Filed: Dec. 23, 2025

(30) Foreign Application Priority Data
Mar. 28, 2025 (JP) 2025-056396

(51) Int. Cl. G06F 21/57; G06F 21/55

(52) U.S. Cl. CPC G06F 21/577; G06F 21/552

(57) ABSTRACT

Vulnerability analysis system includes: vulnerability information receiver that obtains new vulnerability information regarding new vulnerability of a monitoring target that has not been handled in the past by vulnerability analysis system; DFD impact inquirer that obtains unaddressed vulnerability information regarding unaddressed vulnerability of the monitoring target for which a measure has not been completed; vulnerability analyzer that analyzes a risk to the monitoring target due to an attack using the new vulnerability and the unaddressed vulnerability, based on the new vulnerability information and the unaddressed vulnerability information; and display outputter that outputs an analysis result obtained by vulnerability analyzer.

### CROSS REFERENCE TO RELATED APPLICATION

The present application is based on and claims priority of Japanese Patent Application No. 2025-056396 filed on Mar. 28, 2025.

### FIELD

The present disclosure relates to a vulnerability analysis system and a vulnerability analysis method that analyze vulnerability of a monitoring target.

### BACKGROUND

Patent Literature (PTL) 1 discloses a technology for estimating the impact of residual vulnerabilities (hereinafter referred to as unaddressed vulnerabilities) in software installed in a target device (hereinafter referred to as a monitoring target) on other devices connected to the monitoring target.

### Citation List

### Patent Literature

PTL 1: Japanese Unexamined Patent Application Publication No. 2024-68923

### SUMMARY

The technology disclosed in PTL 1 can be improved upon.

Therefore, the present disclosure provides a vulnerability analysis system and the like capable of improving upon the above related art.

The vulnerability analysis system according to the present disclosure is a vulnerability analysis system that analyzes vulnerabilities of a monitoring target, the vulnerability analysis system including: a vulnerability information obtainer that obtains new vulnerability information regarding a new vulnerability of the monitoring target that has not been handled in a past by the vulnerability analysis system; an unaddressed vulnerability information obtainer that obtains unaddressed vulnerability information regarding an unaddressed vulnerability of the monitoring target for which a measure has not been completed; an analyzer that analyzes a risk to the monitoring target due to one of an attack using the new vulnerability or an attack using the unaddressed vulnerability, based on the new vulnerability information and the unaddressed vulnerability information; and an outputter that outputs an analysis result obtained by the analyzer.

The vulnerability analysis method according to the present disclosure is a vulnerability analysis method executed by a vulnerability analysis system that analyzes vulnerabilities of a monitoring target, the vulnerability analysis method including: obtaining new vulnerability information regarding new vulnerability of the monitoring target that has not been handled in a past by the vulnerability analysis system; obtaining unaddressed vulnerability information regarding unaddressed vulnerability of the monitoring target for which a measure has not been completed in the monitoring target; analyzing a risk to the monitoring target due to an attack using the new vulnerability and the unaddressed vulnerability, based on the new vulnerability information and the unaddressed vulnerability information; and outputting an analysis result obtained in the analyzing.

It should be noted that these general or specific aspects may be realized by a system, a method, an integrated circuit, a computer program, or a computer-readable recording medium such as a CD-ROM, or may be realized by any combination of a system, a method, an integrated circuit, a computer program, and a recording medium.

According to the vulnerability analysis system and the like according to one aspect of the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of a vulnerability analysis system according to an embodiment.

FIG. 2 is a flowchart illustrating an example of the operation of the vulnerability analysis system according to the embodiment.

FIG. 3 is a diagram illustrating an example of past analysis data.

FIG. 4 is a diagram illustrating an example of the addressing status of unaddressed vulnerability.

FIG. 5 is a diagram illustrating an example of a data flow diagram (DFD) of a monitoring target.

FIG. 6 is a diagram illustrating an example of difference information.

FIG. 7 is a diagram illustrating an example of a threat scenario.

FIG. 8 is a flowchart illustrating an example of a vulnerability analysis method according to another embodiment.

### DESCRIPTION OF EMBODIMENTS

### Circumstances Leading to One Aspect of the Present Disclosure

When a vulnerability is discovered and reported, it is necessary to perform vulnerability analysis and determine the risk. In vulnerability analysis, feasibility (possibility of attack) and impact are analyzed, but even when analyzing the same vulnerability, feasibility and impact differ depending on the monitoring target. For this reason, in order to improve the accuracy of vulnerability analysis and correctly determine risks, it is necessary to make determination according to the monitoring target.

In addition, when performing vulnerability analysis, it is conceivable to reuse the results of past vulnerability analysis of the monitoring target (for example, asset extraction results, attack paths, threat scenarios, impacts, or the like). However, depending on the vulnerability, addressing may not be completed in the monitoring target. For this reason, when a new vulnerability in a monitoring target is discovered and reported, if there is an unaddressed vulnerability for which addressing has not been completed in the monitoring target, the risk to the monitoring target changes depending on the interaction between the unaddressed vulnerability and the new vulnerability, which may reduce the accuracy of risk analysis. For example, in the technology disclosed in PTL 1, when a new vulnerability in a monitoring target is discovered and reported, and if there is an unaddressed vulnerability for which addressing has not been completed in the monitoring target, the risk to the monitoring target changes due to the interaction between the unaddressed vulnerability and the new vulnerability, which may reduce the accuracy of risk analysis.

Therefore, hereinafter, a vulnerability analysis system and the like that can improve the accuracy of risk analysis when there is an unaddressed vulnerability for which addressing has not been completed in the monitoring target will be explained.

It should be noted that the embodiments described below are comprehensive or specific examples. The numerical values, shapes, materials, components, arrangement positions and connection forms of the components, steps, order of steps, and the like shown in the following embodiment are examples, and are not intended to limit the present disclosure.

### Embodiment

Hereinafter, a vulnerability analysis system according to an embodiment will be described.

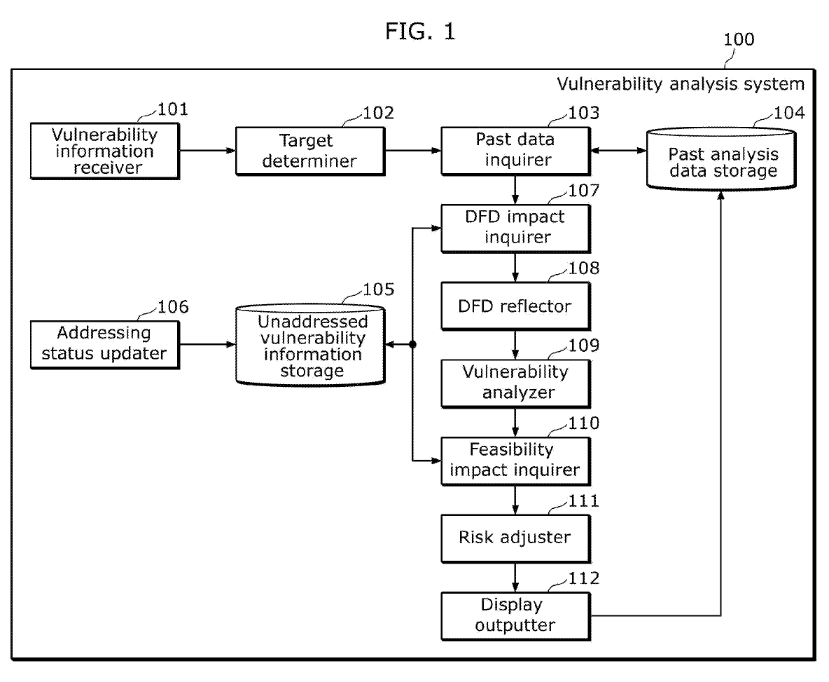

FIG. 1 is a block diagram illustrating an example of vulnerability analysis system 100 according to an embodiment.

Vulnerability analysis system 100 is a system that analyzes vulnerabilities of monitoring targets. The monitoring targets are not particularly limited, but for example, vulnerability analysis system 100 monitors equipment such as home appliances or vehicles, parts included in the equipment, or software for controlling the equipment or the parts.

Vulnerability analysis system 100 includes vulnerability information receiver 101, target determiner 102, past data inquirer 103, past analysis data storage 104, unaddressed vulnerability information storage 105, addressing status updater 106, DFD impact inquirer 107, DFD reflector 108, vulnerability analyzer 109, feasibility impact inquirer 110, risk adjuster 111, and display outputter 112. Vulnerability analysis system 100 is a computer including a processor (microprocessor), memory, and the like. The memory is a read only memory (ROM), random access memory (RAM), and the like, and can store programs executed by the processor. Vulnerability information receiver 101, target determiner 102, past data inquirer 103, addressing status updater 106, DFD impact inquirer 107, DFD reflector 108, vulnerability analyzer 109, feasibility impact inquirer 110, risk adjuster 111, and display outputter 112 are realized by a processor that executes a program stored in a memory, or the like. Past analysis data storage 104 and unaddressed vulnerability information storage 105 may be the same memory that stores the program, or may be a separate memory from the memory that stores the program.

For example, vulnerability analysis system 100 may be a computer (apparatus) housed within a single enclosure, or may be a system consisting of multiple computers. In addition, for example, vulnerability analysis system 100 may be a server. It should be noted that the components included in vulnerability analysis system 100 may be placed on one server, or may be distributed and placed on multiple servers.

Vulnerability information receiver 101 obtains new vulnerability information regarding new vulnerabilities of the monitoring target. A new vulnerability is a vulnerability that has not been handled in the past in vulnerability analysis system 100. For example, vulnerability information receiver 101 receives new vulnerability information regarding various new vulnerabilities of software of various devices (for example, vehicles and the like) from a vulnerability information public database such as National Vulnerability Database (NVD).

For example, the vulnerability information may include Common Vulnerabilities and Exposures (CVE) and the like. CVE is a database that assigns unique names and numbers to vulnerabilities. By using CVE, a unique name and number can be assigned to each vulnerability, making it easier to compare vulnerabilities.

For example, vulnerability information receiver 101 determines whether the new vulnerability indicated by the received new vulnerability information is a vulnerability of the monitoring target to be monitored by vulnerability analysis system 100. For example, vulnerability information receiver 101 can make the above determination by comparing the received new vulnerability information with registered Software Bill Of Materials (SBOM).

Target determiner 102 identifies a device (for example, a vehicle) that is the target of the new vulnerability information.

Past data inquirer 103 makes an inquiry to past analysis data storage 104 that stores past analysis data of the monitoring target, and obtains the past analysis data of the monitoring target from past analysis data storage 104.

Unaddressed vulnerability information storage 105 stores unaddressed vulnerability information regarding unaddressed vulnerabilities of the monitoring target. Unaddressed vulnerabilities are vulnerabilities that have been handled in the past by vulnerability analysis system 100, and for which addressing have not been completed in the monitoring target.

Addressing status updater 106 updates the addressing status of unaddressed vulnerability information. For example, when there is a change in the addressing status of the unaddressed vulnerability indicated by the unaddressed vulnerability information stored in unaddressed vulnerability information storage 105, addressing status updater 106 updates the addressing status of the unaddressed vulnerability information. For example, when addressing of the unaddressed vulnerability indicated by the unaddressed vulnerability information stored in unaddressed vulnerability information storage 105 is completed in the monitoring target, addressing status updater 106 deletes the unaddressed vulnerability information from unaddressed vulnerability information storage 105.

DFD impact inquirer 107 makes an inquiry to unaddressed vulnerability information storage 105 and obtains the unaddressed vulnerability information of the monitoring target. DFD impact inquirer 107 is an example of an unaddressed vulnerability information obtainer. For example, DFD impact inquirer 107 obtains unaddressed vulnerability information that affects the DFD, which indicates the flow of information in the monitoring target.

DFD reflector 108 reflects the impact of unaddressed vulnerabilities on the DFD on the DFD. In addition, when the new vulnerability impacts on the DFD, DFD reflector 108 reflects the impacts of the new vulnerability on the DFD on the DFD.

Vulnerability analyzer 109 analyzes the risk to the monitoring target due to attacks using new vulnerabilities and unaddressed vulnerabilities, based on the new vulnerability information and the unaddressed vulnerability information. For example, vulnerability analyzer 109 analyzes risks based on a DFD that shows the flow of information in the monitoring target and reflects the impacts of attacks using new vulnerabilities and/or the impacts of attacks using unaddressed vulnerabilities.

Feasibility impact inquirer 110 makes an inquiry to unaddressed vulnerability information storage 105 and obtains unaddressed vulnerabilities that impact on feasibility. For example, unaddressed vulnerabilities that impact on feasibility are unaddressed vulnerabilities that are on the attack path in a threat scenario.

Risk adjuster 111 adjusts the risk depending on whether there is a vulnerability that impacts on feasibility.

DFD reflector 108, vulnerability analyzer 109, feasibility impact inquirer 110, and risk adjuster 111 are examples of analyzers.

Display outputter 112 outputs the analysis results obtained by vulnerability analyzer 109 and the like. For example, display outputter 112 may output the analysis result to past analysis data storage 104 and storage it, or may output the analysis result to a display or the like and display it. Display outputter 112 is an example of an outputter.

Next, details of the operation of vulnerability analysis system 100 will be explained.

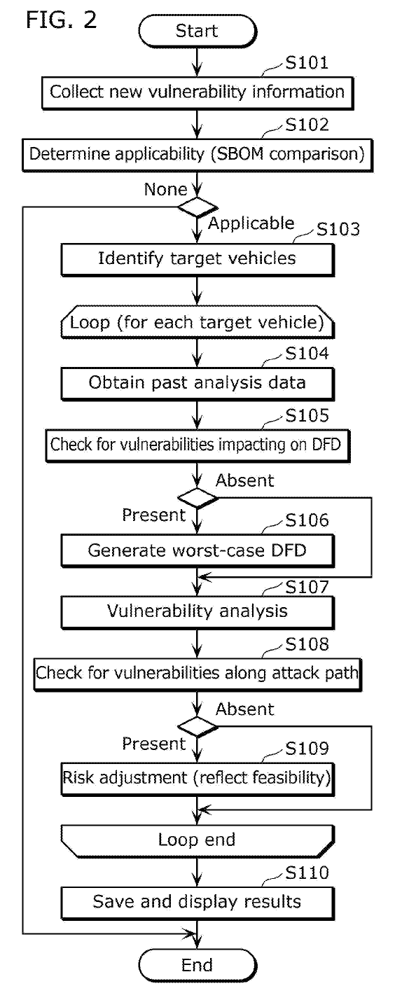

FIG. 2 is a flowchart illustrating an example of the operation of vulnerability analysis system 100 according to the embodiment.

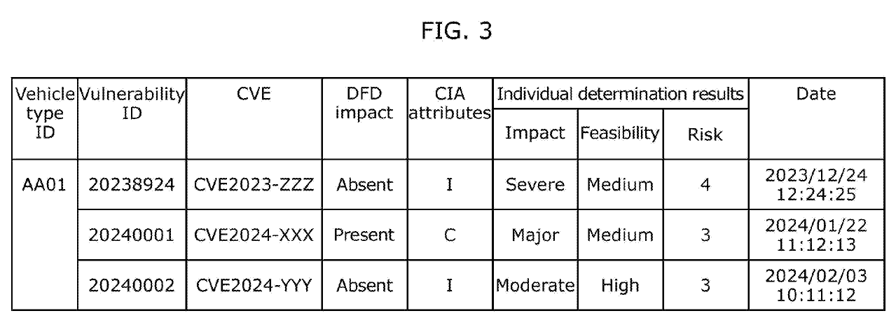

First, vulnerability information receiver 101 collects new vulnerability information such as CVE from NVD and the like (step S101). For example, the new vulnerability information includes the vulnerability ID, CVE, impact on DFD, CIA attribute, and the like, as illustrated in FIG. 3, which will be described later. CIA stands for Confidentiality, Integrity and Availability. It should be noted that the new vulnerability information does not necessarily need to include all information; for example, the new vulnerability information may not include the impact on the DFD.

Next, vulnerability information receiver 101 determines whether the new vulnerability indicated by the collected new vulnerability information corresponds to the vulnerability of the monitoring target by comparing the registered SBOM and the CVE or the like of the received new vulnerability information (step S102). For example, if the registered SBOM describes Common Platform Enumeration (CPE) indicating software that is subject to CVE of the received new vulnerability information, it is determined that the new vulnerability indicated by the received new vulnerability information corresponds to the vulnerability of the monitoring target. If the new vulnerability indicated by the received new vulnerability information does not correspond to the vulnerability of the monitoring target, the process ends. If the new vulnerability indicated by the received new vulnerability information corresponds to the vulnerability of the monitoring target, the processes from step S103 onwards are performed.

Target determiner 102 identifies one or more vehicles that are targets of the new vulnerability information (step S103). For example, vulnerability analysis system 100 stores an SBOM corresponding to each vehicle, and target determiner 102 identifies one or more target vehicles by comparing the CPE described in the CVE and the like of new vulnerability information and the CPE described in the SBOM corresponding to each vehicle. It should be noted that vulnerability analysis system 100 may store an SBOM corresponding to each vehicle group, and target determiner 102 may identify one or more vehicle groups by comparing the CPE described in the CVE and the like of the new vulnerability information and the CPE described in the SBOM corresponding to each vehicle group. Then, the processes from step S104 to step S109 are performed for each target vehicle type corresponding to the identified one or more vehicles or vehicle groups.

Past data inquirer 103 reads and obtains the past analysis data of the vehicle that is the target of the new vulnerability information from past analysis data storage 104 (step S104). It should be noted that when analysis is performed each time, past data inquirer 103 may read only vehicle information, vehicle configuration information, and electronic control unit (ECU) information. In this case, past analysis data may not be stored. Here, an example of past analysis data will be explained with reference to FIG. 3.

FIG. 3 is a diagram illustrating an example of past analysis data. For example, past analysis data includes unaddressed vulnerability information and determination results of the unaddressed vulnerability.

As illustrated in FIG. 3, the past analysis data includes the vehicle type ID, vulnerability ID, CVE, impact on DFD, CIA attribute, individual vulnerability determination results, and the date and time when the analysis was performed. For example, the determination results of the impact of vulnerability include Severe, Major, Moderate, and Negligible. In addition, the vulnerability feasibility determination results include Very Low, Low, Medium, and High. In addition, the vulnerability risk determination results range from 1 to 5 (the larger the value, the greater the risk). For example, the vulnerability ID, CVE, impact on DFD, and CIA attribute are information included in the unaddressed vulnerability information. Information indicating whether there is an impact on the DFD is an example of impact presence information. It should be noted that whether to record as past analysis data may be determined based on any one or any combination of impact, feasibility, and risk.

In this way, the unaddressed vulnerability information may include impact presence information indicating whether the DFD will be impacted on when the monitoring target is attacked using the unaddressed vulnerability.

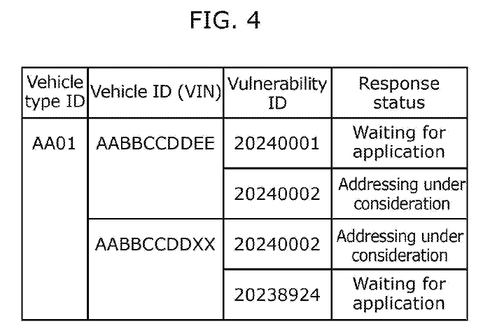

In addition, an example of the addressing status of unaddressed vulnerabilities will be explained with reference to FIG. 4.

FIG. 4 is a diagram illustrating an example of the addressing status of unaddressed vulnerabilities. As illustrated in FIG. 4, it can be seen that the unaddressed vulnerability of the vehicle having vehicle type ID of "AA01" and vehicle ID of "AABBCCDDEE" whose vulnerability ID is "20240001" is unaddressed because it is in a state of waiting for application of addressing to the vulnerability. In addition, it can be seen that the unaddressed vulnerability of the vehicle having vehicle type ID of "AA01" and the vehicle ID of "AABBCCDDEE" and the vehicle having vehicle ID of "AABBCCDDXX" whose vulnerability ID is "20240002" is unaddressed because the addressing to the vulnerability is under consideration. In addition, it can be seen that the unaddressed vulnerability of the vehicle having vehicle type ID of "AA01" and the vehicle ID of "AABBCCDDXX" whose vulnerability ID is "20238924" is unaddressed because it is in a state of waiting for application of addressing to the vulnerability.

It should be noted that it may be determined that the vehicle is unaddressed based on the fact that it is registered as unaddressed vulnerability information without storing the addressing status.

It should be noted that by not storing the vehicle ID, it may be determined that the vehicle is unaddressed on a vehicle type ID basis.

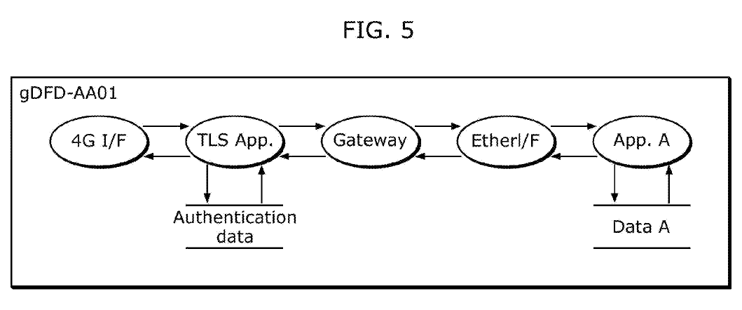

In addition, an example of a DFD will be explained with reference to FIG. 5.

FIG. 5 is a diagram illustrating an example of a DFD of the monitoring target.

FIG. 5 shows a part of the DFD of a vehicle whose vehicle type ID is "AA01". As illustrated FIG. 5, this DFD illustrates that information flows between the 4G interface and the transport layer security (TLS) application, authentication data is input/output to the TLS application, information flows between the TLS application and the gateway, information flows between the gateway and the Ethernet interface, information flows between the Ethernet interface and application A, and data A is input/output to application A.

It should be noted that in this embodiment, a DFD is generated and the attack path is analyzed using the DFD, but it is not limited to the DFD, and the attack path may be analyzed using other methods such as Unified Modeling Language (UML).

Returning to the explanation with reference to FIG. 2, DFD impact inquirer 107 confirms unaddressed vulnerabilities that impact on the DFD of the vehicle targeted by the new vulnerability information (step S105). For example, DFD impact inquirer 107 checks unaddressed vulnerabilities that impact on the DFD based on the impact presence information included in the unaddressed vulnerability information. As illustrated in FIG. 3, since the unaddressed vulnerability having the vulnerability ID of "20240001" includes impact presence information indicating that it has an impact on the DFD, DFD impact inquirer 107 can determine that the unaddressed vulnerability has an impact on the DFD. In this way, DFD impact inquirer 107 may determine whether the impact of an attack using an unaddressed vulnerability is to be reflected in the DFD based on the impact presence information included in the unaddressed vulnerability information. By using the impact presence information, it is possible to easily determine what is to be reflected in the DFD, and the processing can be made more efficient.

If the unaddressed vulnerability that impacts on the DFD is absent, the process in step S106 is not performed, and if the unaddressed vulnerability that impacts on the DFD is present, the process in step S106 is performed.

DFD reflector 108 reflects new vulnerabilities and/or unaddressed vulnerabilities that impact on the DFD on the DFD. For example, if a plurality of items of unaddressed vulnerability information regarding unaddressed vulnerabilities that impact on the DFD are obtained, DFD reflector 108 generates a worst case DFD (step S106). The worst case DFD is a worst case DFD that reflects all the impacts of attacks using new vulnerabilities and/or attacks using unaddressed vulnerabilities for each of a plurality of items of unaddressed vulnerability information. When there is a plurality of items of unaddressed vulnerability information, by generating a worst case DFD that reflects all the impacts of attacks using each vulnerability, processing can be made more efficient than when a DFD is generated for each combination of vulnerability information. It should be noted that although an example in which the worst case DFD is generated is shown here, the worst case DFD does not need to be generated.

It should be noted that one or more DFDs may be generated without generating a worst case DFD, by individually selecting one or more impacts of attacks using new vulnerabilities and/or impacts of attacks using unaddressed vulnerability for each of a plurality of items of unaddressed vulnerability information, or by arbitrarily combining one or more of them. The selection and combination methods may be based on user specifications, characteristics such as risks recorded in unaddressed vulnerability information, or time stamps. When one or more DFDs are generated, predetermined processing such as risk analysis may be performed on each DFD in subsequent steps.

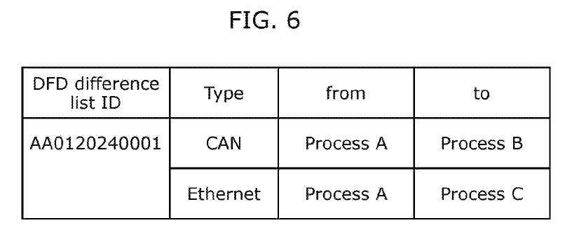

For example, the unaddressed vulnerability information may include, as differential information, the impact on the DFD when the monitoring target is attacked using the unaddressed vulnerability. Here, an example of the difference information will be explained with reference to FIG. 6.

FIG. 6 is a diagram illustrating an example of difference information.

For example, the difference information indicates a process that is impacted in the DFD when a monitoring target is attacked using vulnerability. In the example illustrated in FIG. 6, CAN processes A to B and Ethernet processes A to C are illustrated as impacted processes in the DFD.

DFD reflector 108 may generate a DFD reflecting the impact of attacks using unaddressed vulnerabilities by reflecting such differential information contained in the unaddressed vulnerability information on the DFD. This eliminates the need to generate a DFD reflecting the impact of attacks using unaddressed vulnerabilities from scratch, and simply reflecting the differential information on the existing DFD allows for the easy generation of a DFD reflecting the impact of attacks using unaddressed vulnerabilities, thereby making the process more efficient.

It should be noted that the impact of an attack using a new vulnerability is determined by analyzing the new vulnerability, and once the new vulnerability is analyzed by vulnerability analysis system 100, it becomes an unaddressed vulnerability (if it is unaddressed). For this reason, once the new vulnerability is analyzed, the impact of an attack using the new vulnerability will be included in the unaddressed vulnerability information as the impact of an attack using the unaddressed vulnerability. Therefore, from now on, the impact of an attack using the new vulnerability can be reflected in the DFD as the impact of an attack using an unaddressed vulnerability.

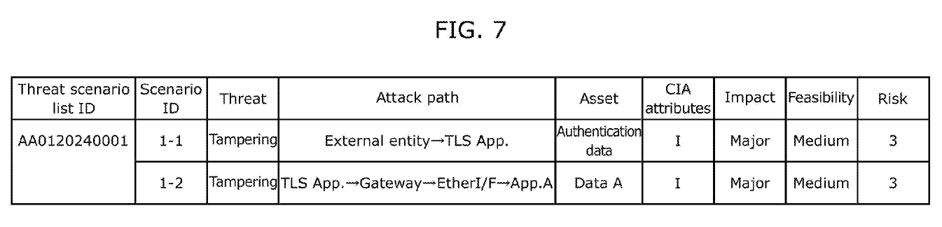

Returning to the explanation in FIG. 2, vulnerability analyzer 109 analyzes the risk to the monitoring target due to an attack using the new vulnerability and the unaddressed vulnerability, based on the new vulnerability information and the unaddressed vulnerability information (step S107). For example, vulnerability analyzer 109 analyzes risks (for example, calculates feasibility and impact) by generating a threat scenario using a DFD generated based on new vulnerability information and unaddressed vulnerability information. Here, an example of a threat scenario will be explained with reference to FIG. 7.

FIG. 7 is a diagram illustrating an example of a threat scenario. For example, the threat scenario includes a threat scenario list ID, scenario ID, threat, attack path, asset, CIA attribute, impact, feasibility, and risk.

Returning to the explanation with reference to FIG. 2, feasibility impact inquirer 110 checks whether there are new vulnerabilities and/or unaddressed vulnerabilities on the attack path used in the generated threat scenario (step S108). For example, in the attack path of TCU (4G interface, TLS, Ethernet interface), gateway, and C-ECU (Ethernet interface, application), it is confirmed whether there are new vulnerabilities and/or unaddressed vulnerabilities on each module.

If there are no new vulnerabilities and/or unaddressed vulnerabilities on the attack path, the process in step S109 is not performed, and if there are new vulnerabilities and/or unaddressed vulnerabilities on the attack path, the process in step S109 is performed.

Risk adjuster 111 adjusts the risk by recalculating the feasibility and reflecting it in the risk analysis according to new vulnerabilities and/or unaddressed vulnerabilities on the attack path (step S109). For example, if there is a new vulnerability or an unaddressed vulnerability in the TLS module of the TCU, and there is a possibility that the key may be leaked, the feasibility becomes high and the risk increases. It should be noted that when there are a plurality of new vulnerabilities and/or unaddressed vulnerabilities on the attack path, risk adjuster 111 may recalculate the feasibility using some or any combination of them, reflect it in the risk analysis, and output one or more risk values as the analysis results. It should be noted that the selection and combination methods may be based on user specifications, characteristics such as risks recorded in unaddressed vulnerability information, or time stamps. When one or more risk values are output, predetermined processing may be performed for each risk value in subsequent steps.

Then, display outputter 112 stores and displays the analysis results (step S110).

As explained above, when a monitoring target includes an unaddressed vulnerability for which addressing has not been completed in the monitoring target, not only the new vulnerability information but also the unaddressed vulnerability information is used to analyze the risk to the monitoring target due to attacks using the new vulnerability and unaddressed vulnerability, in other words, the risk to the monitoring target that changes due to the interaction between the unaddressed vulnerability and the new vulnerability. Therefore, if there is an unaddressed vulnerability for which addressing has not been completed in the monitoring target, the accuracy of risk analysis can be improved. In addition, by using DFD, risk analysis can be performed efficiently.

### Other Embodiments

As described above, the embodiment has been described as an example of the technology according to the present disclosure. However, the technology according to the present disclosure is not limited thereto, and can also be applied to embodiments in which changes, replacements, additions, omissions, or the like are made as appropriate. For example, the following variations are also included in the embodiment of the present disclosure.

For example, display outputter 112 may output the impact on the DFD when the monitoring target is attacked using the new vulnerabilities and unaddressed vulnerabilities that have been used to obtain the analysis results. By indicating the impact of the vulnerability on the DFD (for example, whether an attack path has been added to the DFD, and the like), processing at the subsequent stages such as detailed analysis or consideration of addressing can be made more efficient.

For example, when a plurality of items of unaddressed vulnerability information are obtained, vulnerability analyzer 109 may analyze the risk based on the new vulnerability information and one or more items of unaddressed vulnerability information among the plurality of items of unaddressed vulnerability information. When there are a plurality of items of unaddressed vulnerability information, risk analysis does not necessarily need to be performed using all of the items of unaddressed vulnerability information, and risk analysis may be performed using one or more items of unaddressed vulnerability information.

For example, vulnerability analyzer 109 may analyze risks for each of possible combinations of the new vulnerability information and one or more items of unaddressed vulnerability information among the plurality of items of unaddressed vulnerability information. Because risk analysis is performed for each of the combinations of vulnerability information, it is possible to clarify which combinations of vulnerabilities should be addressed.

For example, display outputter 112 may output combinations based on which the risk has a value greater than or equal to a predetermined threshold among the possible combinations of the new vulnerability information and the one or more items of unaddressed vulnerability information, or may not output combinations based on which the risk has a value less than the predetermined threshold. In this way, by narrowing down the combinations of vulnerabilities that pose a high risk, processing at the subsequent stages can be made more efficient.

For example, vulnerability analyzer 109 may determine one or more items of unaddressed vulnerability information that are not to be used for risk analysis from among the plurality of items of unaddressed vulnerability information, based on the progress of addressing the unaddressed vulnerability, presence or absence of an addressing plan, or a period of addressing, which is indicated by each of the plurality of items of unaddressed vulnerability information. It is possible to determine which unaddressed vulnerabilities are likely to be addressed based on the progress of addressing the unaddressed vulnerability, presence or absence of an addressing plan, or a period of addressing. Therefore, processing can be made more efficient by excluding unaddressed vulnerability information indicating unaddressed vulnerabilities that are likely to be addressed from unaddressed vulnerability information used for risk analysis.

For example, vulnerability analyzer 109 may analyze the degree of contribution to the risk of each of possible combinations of the new vulnerability information and one or more items of unaddressed vulnerability information among a plurality of items of unaddressed vulnerability information (for example, the degree of contribution to the impact, the degree of contribution to the decrease in feasibility, or the like), and display outputter 112 may display the above combinations side by side in an order according to the degree of contribution. This makes it possible to grasp combinations of vulnerability information that have a high degree of contribution to risk. That is, by making it easier to grasp the combinations of vulnerabilities that need to be addressed, processing at the subsequent stages can be made more efficient.

For example, vulnerability analyzer 109 may determine one or more items of unaddressed vulnerability information specified by the user from among a plurality of items of unaddressed vulnerability information. In this way, when unaddressed vulnerabilities to be considered are specified, risk analysis can be performed by limiting the unaddressed vulnerability information.

For example, vulnerability analyzer 109 may analyze the risk to the monitoring target due to an attack using the new vulnerability based on the new vulnerability information. In this way, in parallel with the risk analysis for the monitoring target that changes due to the interaction between unaddressed vulnerabilities and new vulnerabilities, the risk analysis for the monitoring target for the new vulnerability alone may be performed, and the analysis results for the new vulnerability alone can be used to determine the countermeasure policy. For example, if the risk of a new vulnerability alone is high, priority can be given to addressing to the new vulnerability.

For example, display outputter 112 may output new vulnerability information and unaddressed vulnerability information that have been used to obtain the analysis results. By outputting (for example, recording or displaying) vulnerability information used in risk analysis, it is possible to easily grasp vulnerabilities that cause risks and to make processing at the subsequent stages more efficient.

For example, the present disclosure can be realized not only as vulnerability analysis system 100 but also as a vulnerability analysis method including steps (processing) performed by the components included in vulnerability analysis system 100.

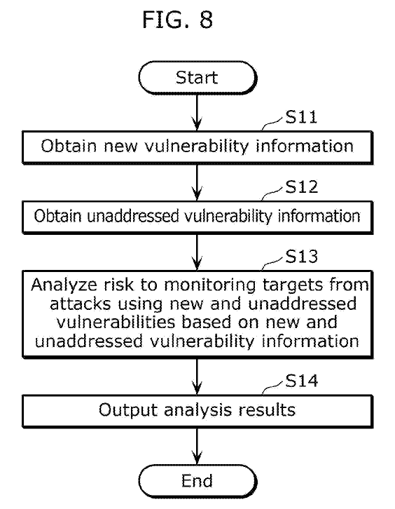

FIG. 8 is a flowchart illustrating an example of a vulnerability analysis method according to another embodiment.

The vulnerability analysis method is a vulnerability analysis method executed by vulnerability analysis system 100 that analyzes vulnerability of a monitoring target, as illustrated in FIG. 8, the vulnerability analysis method including: obtaining new vulnerability information regarding new vulnerability of the monitoring target that has not been handled in a past by the vulnerability analysis system (step S11); obtaining unaddressed vulnerability information regarding unaddressed vulnerability of the monitoring target for which a measure has not been completed in the monitoring target (step S12); analyzing a risk to the monitoring target due to an attack using the new vulnerability and the unaddressed vulnerability, based on the new vulnerability information and the unaddressed vulnerability information (step S13); and outputting an analysis result obtained in the analyzing (step S14).

For example, the present disclosure can be realized as a program for causing a computer (processor) to execute the steps included in the vulnerability analysis method. Furthermore, the present disclosure can be realized as a non-transitory computer-readable recording medium such as a CD-ROM on which the program is recorded.

For example, when the present disclosure is realized as a program (software), each step is executed by executing the program using hardware resources such as a computer's CPU, memory, and input/output circuits. That is, each step is executed by the CPU obtaining data from a memory, input/output circuit, or the like to perform calculations, and outputting the calculation results to the memory, input/output circuit, or the like.

It should be noted that in the above embodiment, each component included in vulnerability analysis system 100 may be configured with dedicated hardware, or may be realized by executing a software program suitable for each component. Each component may be realized by a program executor such as a CPU or a processor reading out and executing a software program recorded on a recording medium such as a hard disk or a semiconductor memory.

Some or all of the functions of vulnerability analysis system 100 according to the above embodiment are typically realized as an LSI, which is an integrated circuit. These may be integrated into one chip individually, or may be integrated into one chip so as to include some or all of them. In addition, circuit integration is not limited to LSI, and may be realized using a dedicated circuit or a general-purpose processor. A field programmable gate array (FPGA) that can be programmed after the LSI is manufactured, or a reconfigurable processor that can reconfigure the connections and settings of circuit cells inside the LSI may be used.

Furthermore, if an integrated circuit technology that replaces an LSI appears due to advances in semiconductor technology or another technology derived therefrom, that technology may naturally be used to integrate each component included in vulnerability analysis system 100.

In addition, forms obtained by applying various modifications to the embodiment conceived by a person skilled in the art or forms realized by arbitrarily combining the components and functions in each embodiment without departing from the spirit of the present disclosure are also included in this disclosure.

### Additional note

The following technologies are disclosed by the description of the embodiment above.

(Technology 1) A vulnerability analysis system that analyzes vulnerabilities of a monitoring target, the vulnerability analysis system including: a vulnerability information obtainer that obtains new vulnerability information regarding a new vulnerability of the monitoring target that has not been handled in a past by the vulnerability analysis system; an unaddressed vulnerability information obtainer that obtains unaddressed vulnerability information regarding an unaddressed vulnerability of the monitoring target for which a measure has not been completed; an analyzer that analyzes a risk to the monitoring target due to one of an attack using the new vulnerability or an attack using the unaddressed vulnerability, based on the new vulnerability information and the unaddressed vulnerability information; and an outputter that outputs an analysis result obtained by the analyzer.

According to this, when there is an unaddressed vulnerability for which addressing has not been completed in the monitoring target, not only new vulnerability information but also unaddressed vulnerability information is used to analyze the risk to the monitoring target due to attacks using the new vulnerability and unaddressed vulnerability, in other words, the risk to the monitoring target that changes due to the interaction between the unaddressed vulnerability and the new vulnerability. Therefore, if there is an unaddressed vulnerability in the monitoring target, the accuracy of risk analysis can be improved.

(Technology 2) The vulnerability analysis system according to technology 1, wherein the analyzer analyzes the risk based on a data flow diagram (DFD) showing a flow of information in the monitoring target, the DFD reflecting at least one of an impact of the attack using the new vulnerability or an impact of the attack using the unaddressed vulnerability.

According to this, risk analysis can be performed efficiently by using DFD.

(Technology 3) The vulnerability analysis system according to technology 2, wherein the unaddressed vulnerability information includes impact presence information indicating whether the DFD is impacted when the monitoring target is attacked using the unaddressed vulnerability, and the analyzer further determines whether to reflect the impact of the attack using the unaddressed vulnerability on the DFD, based on the impact presence information included in the unaddressed vulnerability information.

According to this, by using the impact presence information, it is possible to easily determine a reflection target on the DFD, and the processing can be made more efficient.

(Technology 4) The vulnerability analysis system according to technology 2 or 3, wherein the unaddressed vulnerability information includes, as differential information, an impact on the DFD when the monitoring target is attacked using the unaddressed vulnerability, and the analyzer further reflects the differential information included in the unaddressed vulnerability information on the DFD.

According to this, there is no need to generate a DFD that reflects the impacts due to attacks using unaddressed vulnerabilities from scratch, and by simply reflecting the difference information in the current DFD, it is possible to easily generate a DFD that reflects the impacts of attacks using unaddressed vulnerabilities, and processing can be made more efficient.

(Technology 5) The vulnerability analysis system according to any one of technologies 2 to 4, wherein the outputter further outputs the impact on the DFD when the monitoring target is attacked using the new vulnerability and the unaddressed vulnerability that have been used to obtain the analysis result.

According to this, by showing the impact of the vulnerability on the DFD (for example, whether an attack path has been added to the DFD), processing at the subsequent stages such as detailed analysis or consideration of addressing can be made more efficient.

(Technology 6) The vulnerability analysis system according to any one of technologies 2 to 5, wherein when a plurality of items of unaddressed vulnerability information are obtained, the analyzer analyzes the risk based on the DFD that reflects at least one of the impact of the attack using the new vulnerability or all of impacts of attacks using unaddressed vulnerabilities indicated by the plurality of items of unaddressed vulnerability information.

According to this, when there are a plurality of items of unaddressed vulnerability information, a worst case DFD is generated that reflects all the impacts of attacks using each vulnerability, so it is possible to make processing more efficient than when a DFD is generated for each combination of vulnerability information.

(Technology 7) The vulnerability analysis system according to any one of technologies 1 to 6, wherein when a plurality of items of unaddressed vulnerability information are obtained, the analyzer analyzes the risk based on the new vulnerability information and one or more items of unaddressed vulnerability information among the plurality of items of unaddressed vulnerability information.

According to this, when there are a plurality of items of unaddressed vulnerability information, risk analysis does not necessarily need to be performed using all of the plurality of items of unaddressed vulnerability information, and risk analysis may be performed using one or more items of unaddressed vulnerability information.

(Technology 8) The vulnerability analysis system according to technology 7, wherein the analyzer analyzes the risk for each of possible combinations of the new vulnerability information and the one or more items of unaddressed vulnerability information.

According to this, risk analysis is performed for each combination of vulnerability information, so it is possible to clarify the combination of vulnerabilities that should be addressed.

(Technology 9) The vulnerability analysis system according to technology 8, wherein the outputter further outputs, among the combinations, a combination based on which the risk has a value greater than or equal to a predetermined threshold, and does not output a combination based on which the risk has a value less than the predetermined threshold.

According to this, the processing at the subsequent stages can be made more efficient by narrowing down the combinations of vulnerabilities that pose a high risk.

(Technology 10) The vulnerability analysis system according to any one of technologies 7 to 9, wherein the analyzer further determines, from among the plurality of items of unaddressed vulnerability information, one or more items of unaddressed vulnerability information which are not to be used for analyzing the risk, based on at least one of progress of addressing the unaddressed vulnerability, presence or absence of a plan for addressing the unaddressed vulnerability, or a period for addressing the unaddressed vulnerability, the progress, the presence or absence, and the period being indicated by each of the plurality of items of unaddressed vulnerability information.

According to this, unaddressed vulnerabilities that are likely to be addressed can be determined based on the progress of addressing the unaddressed vulnerabilities, presence or absence of an addressing plan, or addressing period. Therefore, processing can be made more efficient by excluding unaddressed vulnerability information indicating unaddressed vulnerabilities that are likely to be addressed from unaddressed vulnerability information used for risk analysis.

(Technology 11) The vulnerability analysis system according to any one of technologies 7 to 10, wherein the analyzer further analyzes a degree of contribution to the risk for each of possible combinations of the new vulnerability information and the one or more items of unaddressed vulnerability information among the plurality of items of unaddressed vulnerability information, and the outputter further displays the combinations in order according to the degree of contribution.

According to this, it is possible to grasp combinations of vulnerability information that have a high degree of contribution to risk. That is, by making it easier to grasp the combinations of vulnerabilities that need to be addressed, the processing at the subsequent stages can be made more efficient.

(Technology 12) The vulnerability analysis system according to any one of technologies 7 to 11, wherein the analyzer further determines, from among the plurality of items of unaddressed vulnerability information, one or more items of unaddressed vulnerability information specified by a user.

According to this, when unaddressed vulnerabilities to be considered are specified, risk analysis can be performed by limiting the unaddressed vulnerability information.

(Technology 13) The vulnerability analysis system according to any one of technologies 1 to 12, wherein the analyzer further analyzes the risk to the monitoring target due to the attack using the new vulnerability, based on the new vulnerability information.

According to this, in parallel with the risk analysis for the monitoring target that changes due to the interaction between the unaddressed vulnerability and the new vulnerability, the risk analysis for the monitoring target for the new vulnerability alone may be performed, and the analysis result for the new vulnerability alone can be used to determine the countermeasure policy. For example, if the risk of a new vulnerability alone is high, priority can be given to addressing to the new vulnerability.

(Technology 14) The vulnerability analysis system according to any one of technologies 1 to 13, wherein the outputter further outputs the new vulnerability information and the unaddressed vulnerability information that have been used to obtain the analysis result.

According to this, by outputting (for example, recording or displaying) the vulnerability information used for risk analysis, it is possible to easily grasp vulnerabilities that cause risks, and to make the processing at the subsequent stages more efficient.

(Technology 15) A vulnerability analysis method executed by a vulnerability analysis system that analyzes vulnerabilities of a monitoring target, the vulnerability analysis method including: obtaining new vulnerability information regarding new vulnerability of the monitoring target that has not been handled in a past by the vulnerability analysis system; obtaining unaddressed vulnerability information regarding unaddressed vulnerability of the monitoring target for which a measure has not been completed in the monitoring target; analyzing a risk to the monitoring target due to an attack using the new vulnerability and the unaddressed vulnerability, based on the new vulnerability information and the unaddressed vulnerability information; and outputting an analysis result obtained in the analyzing.

According to this, it is possible to provide a vulnerability analysis method that can improve the accuracy of risk analysis when there is an unaddressed vulnerability for which addressing has not been completed in the monitoring target.

### Further Information about Technical Background to this Application

The disclosure of the following patent application including specification, drawings, and claims is incorporated herein by reference in its entirety: Japanese Patent Application No. 2025-056396 filed on Mar. 28, 2025.

### INDUSTRIAL APPLICABILITY

The present disclosure can be applied to systems and the like for analyzing vulnerabilities.

1. A vulnerability analysis system that analyzes vulnerabilities of a monitoring target, the vulnerability analysis system comprising:
a vulnerability information obtainer that obtains new vulnerability information regarding a new vulnerability of the monitoring target that has not been handled in a past by the vulnerability analysis system;
an unaddressed vulnerability information obtainer that obtains unaddressed vulnerability information regarding an unaddressed vulnerability of the monitoring target for which a measure has not been completed;
an analyzer that analyzes a risk to the monitoring target due to one of an attack using the new vulnerability or an attack using the unaddressed vulnerability, based on the new vulnerability information and the unaddressed vulnerability information; and
an outputter that outputs an analysis result obtained by the analyzer.

2. The vulnerability analysis system according to claim 1, wherein
the analyzer analyzes the risk based on a data flow diagram (DFD) showing a flow of information in the monitoring target, the DFD reflecting at least one of an impact of the attack using the new vulnerability or an impact of the attack using the unaddressed vulnerability.

3. The vulnerability analysis system according to claim 2, wherein
the unaddressed vulnerability information includes impact presence information indicating whether the DFD is impacted when the monitoring target is attacked using the unaddressed vulnerability, and
the analyzer further determines whether to reflect the impact of the attack using the unaddressed vulnerability on the DFD, based on the impact presence information included in the unaddressed vulnerability information.

4. The vulnerability analysis system according to claim 2, wherein
the unaddressed vulnerability information includes, as differential information, an impact on the DFD when the monitoring target is attacked using the unaddressed vulnerability, and
the analyzer further reflects the differential information included in the unaddressed vulnerability information on the DFD.

5. The vulnerability analysis system according to claim 2, wherein
the outputter further outputs the impact on the DFD when the monitoring target is attacked using the new vulnerability and the unaddressed vulnerability that have been used to obtain the analysis result.

6. The vulnerability analysis system according to claim 2, wherein
when a plurality of items of unaddressed vulnerability information are obtained, the analyzer analyzes the risk based on the DFD that reflects at least one of the impact of the attack using the new vulnerability or all of impacts of attacks using unaddressed vulnerabilities indicated by the plurality of items of unaddressed vulnerability information.

7. The vulnerability analysis system according to claim 1, wherein
when a plurality of items of unaddressed vulnerability information are obtained, the analyzer analyzes the risk based on the new vulnerability information and one or more items of unaddressed vulnerability information among the plurality of items of unaddressed vulnerability information.

8. The vulnerability analysis system according to claim 7, wherein
the analyzer analyzes the risk for each of possible combinations of the new vulnerability information and the one or more items of unaddressed vulnerability information.

9. The vulnerability analysis system according to claim 8, wherein
the outputter further outputs, among the combinations, a combination based on which the risk has a value greater than or equal to a predetermined threshold, and does not output a combination based on which the risk has a value less than the predetermined threshold.

10. The vulnerability analysis system according to claim 7, wherein
the analyzer further determines, from among the plurality of items of unaddressed vulnerability information, one or more items of unaddressed vulnerability information which are not to be used for analyzing the risk, based on at least one of progress of addressing the unaddressed vulnerability, presence or absence of a plan for addressing the unaddressed vulnerability, or a period for addressing the unaddressed vulnerability, the progress, the presence or absence, and the period being indicated by each of the plurality of items of unaddressed vulnerability information.

11. The vulnerability analysis system according to claim 7, wherein
the analyzer further analyzes a degree of contribution to the risk for each of possible combinations of the new vulnerability information and the one or more items of unaddressed vulnerability information among the plurality of items of unaddressed vulnerability information, and
the outputter further displays the combinations in order according to the degree of contribution.

12. The vulnerability analysis system according to claim 7, wherein
the analyzer further determines, from among the plurality of items of unaddressed vulnerability information, one or more items of unaddressed vulnerability information specified by a user.

13. The vulnerability analysis system according to claim 1, wherein
the analyzer further analyzes the risk to the monitoring target due to the attack using the new vulnerability, based on the new vulnerability information.

14. The vulnerability analysis system according to claim 1, wherein
the outputter further outputs the new vulnerability information and the unaddressed vulnerability information that have been used to obtain the analysis result.

15. A vulnerability analysis method executed by a vulnerability analysis system that analyzes vulnerabilities of a monitoring target, the vulnerability analysis method comprising:
obtaining new vulnerability information regarding new vulnerability of the monitoring target that has not been handled in a past by the vulnerability analysis system;
obtaining unaddressed vulnerability information regarding unaddressed vulnerability of the monitoring target for which a measure has not been completed in the monitoring target;
analyzing a risk to the monitoring target due to an attack using the new vulnerability and the unaddressed vulnerability, based on the new vulnerability information and the unaddressed vulnerability information; and
outputting an analysis result obtained in the analyzing.
